(19) United States
(12) Patent Application Publication
(10) Pub. No.: US 2025/0091869 A1
(43) Pub. Date: Mar. 20, 2025

(54) MONO PRESSURE SYSTEM FOR PRODUCING NITRIC ACID AND METHOD OF OPERATING THEREOF

(71) Applicant: Yara International ASA, Oslo (NO)

(72) Inventors: Bent VIGELAND, Skien (NO); Halvor ØIEN, Porsgrunn (NO); Krzysztof BANASIAK, Trondheim (NO); Andre DE SMET, Terneuzen (NL); Peter FAUCONNIER, Grimbergen (BE)

(21) Appl. No.: 18/291,460

(22) PCT Filed: Aug. 25, 2022
(86) PCT No.: PCT/EP2022/073641

§ 371 Date: Jan. 23, 2024

(30) Foreign Application Priority Data
Aug. 25, 2021 (EP) 21193034.2

(51) Int. Cl. C01B 21/46; F01K 23/06

(52) U.S. Cl. CPC C01B 21/46; F01K 23/064

(57) ABSTRACT

A system for producing nitric acid at reduced power consumption, including an air compressor producing a compressed air stream; a source of pressurized oxygen-rich gas having a pressure higher than the pressure of the compressed air stream; a mixing apparatus for mixing the oxygen-rich gas/compressed air stream mixture with an ammonia gas stream; an ammonia converter to provide in a NOₓ gas/steam mixture; a water cooler/condenser for separating and condensing steam from NOₓ gas in the gaseous NOₓ gas/steam mixture; an absorption tower downstream the water cooler/condenser, for absorbing NOₓ gases in water, to provide in a stream of raw nitric acid-containing residual NOₓ gas and a tail gas including NOₓ gases. The system further includes a mechanism for splitting the tail gas into a first tail gas stream and a second tail gas stream; and a mechanism for adjusting the amount of tail gas being split.

### FIELD

The present disclosure relates to the field of nitric acid production in a mono pressure plant.

### BACKGROUND

Pure nitric acid is a clear, colorless liquid with a strong odor. Nitric acid is produced in large quantities principally by catalytic oxidation of ammonia (Ostwald process). Ammonia is converted to nitric acid in two stages. The ammonia is first oxidized in an ammonia burner on platinum gauzes (commonly called ammonia converter), producing nitric oxide (in this disclosure also called nitrogen monoxide (NO)) and water:

4NH₃(g)+5O₂(g)→4NO (g)+6H₂O (g) (1)

The reaction product from (1), nitric oxide, following cooling, is then oxidized to nitrogen dioxide (NO₂) and further to dinitrogen tetroxide N₂O₄ (g) in an oxidation section:

2NO (g)+O₂(g)→2NO₂(g) (2)

2NO₂(g)→N₂O₄(g) (3)

Cooling of nitrogen oxide gases is accomplished first through the use of a waste heat recovery system recovering the heat from the conversion of ammonia into nitric oxide, then through the use of a cooler condenser in which condensed nitric acid is separated from nitric oxide, nitrogen dioxide and dinitrogen tetroxide and nitric acid gases, collectively called NOx gases, and finally by heating the tail gas released at the outlet of the absorption tower in which the NOx gases are absorbed.

By absorption in water, nitrogen dioxide and dinitrogen tetroxide are converted to nitric acid and nitric oxide:

3NO₂(g)+H₂O(l)→2HNO₃(aq)+NO(g) (4)

3N₂O₄(g)+2H₂O(l)→4HNO₃(aq)+2NO (g) (5)

Weak nitric acid which is up to 68% (azeotrope) is obtained. Through a rectification process the concentration of nitric acid can be increased up to 99% concentrated nitric acid. The total reaction is given by the following formula:

NH₃+2O₂→HNO₃+H₂O (6)

The main process units in a nitric acid production plant, include an ammonia converter (conversion of ammonia into nitric oxides using oxygen over a suitable catalyst), an oxidation section (conversion of nitric oxide into nitrogen dioxide and nitrogen tetroxide), an absorber unit (for the absorption of NOx gases into water) and a bleacher unit (removal of unreacted dissolved gases, containing in particular NOx and gases, from the aqueous nitric acid solution, which give it its typical brownish color).

The process for the production of nitric acid can be differentiated into a mono-pressure (single-pressure) and dual pressure (split-pressure) process.

In a mono-pressure process, the converter and the absorber unit operate at roughly the same working pressure. Such mono-pressure process generally includes low-pressure processes, LP, from 2 to 6 bar; and high pressure processes, HP, from 6 to 16 bar, in particular from 9 to 16 bar.

The drive power for the air compressor typically originates from a tail-gas turbine and a steam turbine or electric motor. Accordingly, the compressor train of a mono-pressure nitric acid production plant typically comprises an air compressor, a tail-gas turbine, and a steam turbine or electric motor.

More in detail, referring to FIG. 1, a mono-pressure plant and process according to the prior art works as follows. Gaseous ammonia 32, optionally pre-heated in a pre-heater unit (not shown) is mixed with compressed air 34 pressurized using an air compressor 36, in a mixing apparatus 35, and the resulting ammonia/oxygen-enriched air mixture 14 is fed to an ammonia converter 37, where ammonia is oxidized over a suitable catalyst, thus obtaining a NOₓ gas/steam mixture 15, comprising water and nitric oxide (NO). The heat of the mixture coming out of the ammonia converter is recovered, after which the NOₓ gas/stream mixture is subsequently cooled down in a water cooler/condenser 38 to a temperature where the water condenses, and an aqueous diluted nitric acid mixture 17 is separated from a gaseous NOₓ stream 22. The gaseous NOₓ stream is further oxidized to further convert the NO to NO₂ and N₂O₄, and optionally cooled down again in a cooler/separator 39 to separate out another aqueous diluted nitric acid mixture 17 which is directed to an absorption tower 41, commonly called absorption tower. On the other end, the gaseous NOₓ stream 22 is sent to the absorber unit 41 too. Inside the absorber unit 41, the NOₓ gas reacts with water to produce the tail gas 5 and a stream of raw nitric acid 27 also containing residual NOₓ gas, which is fed to a bleacher (not shown). The residual NOₓ gas in the raw nitric acid stream 27 is then stripped out with a gaseous medium (not shown) such as an oxygen-containing gas or air, inside the bleacher unit (not shown); the bleacher unit is generally operated at about the same pressure as the ammonia converter. The drive power for both the air compressor 36 originates from a tail gas expander 7 and a steam turbine 51 or electric motor (not shown). The heat generated in the ammonia converter 37 or from the gaseous NOx stream 15 can be used for producing steam for a steam turbine 51. The optionally heated tail gas 5 is expanded in the tail gas expander 7.

The air used for the oxidation of ammonia is commonly denoted as primary air; the air used as stripping medium in the bleacher unit is commonly denoted as secondary air.

According to the prior art, the revamping of the nitric acid production plants to increase its capacity is commonly based on increasing the amount of primary air to the reactor, which leads to a proportional increase of the amount of nitric acid produced.

The increase of the amount of primary air in the reactor entails the installation of a new air compressor or the revamping of the existing one. This revamping has significant drawbacks. First of all, it entails elevated costs for the modification or replacement of the existing equipment, i.e. the air compressor and the corresponding turbines and electrical motor. In addition, the revamping of the equipment is also technically demanding, leading to long plant downtime.

Another problem related to nitric acid production plants is the high amount of energy required in order to operate the air compressor. Consequently, a high amount of energy is required to achieve the targeted nitric acid production throughput.

A goal of the present invention, therefore, is to provide a system and a method for operating the system which allows for the reduction of power required to operate the air compressor in a mono nitric acid plant.

In CN110540178A (China Chengda Engineering Co Ltd, 2019), a process for producing nitric acid is disclosed. Nitric acid is produced by a medium pressure method, which is characterized in that it comprises the following steps: the ammonia oxidation and absorption pressure is 0.5-0.6 MPa; enabling the tail gas leaving the absorption tower to pass through a carbon molecular sieve Temperature Swing Adsorption (TSA) treatment device to reduce the content of nitrogen oxides in the tail gas to be less than 100 mg/Nm³; the process air of the air compressor is used as the regeneration desorption gas of the carbon molecular sieve temperature swing adsorption treatment device, and the regeneration desorption gas containing the nitrogen oxide can be returned to the ammonia oxidation reactor for reuse; adding a layer of N₂O decomposition catalyst in the oxidation reactor to reduce the content of N₂O to 50-100 PPM through reaction; the nitric acid bleaching tower is arranged at the bottom of the absorption tower, and the two towers are integrated, so that the process flow is shortened, and the equipment investment is reduced. With regard to the amount of air being compressed by the air compressor, however, the same amount of air is to be compressed as would be in the absence of the TSA unit: in the presence of the TSA unit, the amount of air being compressed is initially split between the TSA unit and the ammonia oxidation reactor directly and, in the end, with the amount of compressed air leaving the TSA unit being directed also to the ammonia oxidation reactor, the total amount of air compressed by the air compressor ends up in the ammonia oxidation reactor.

In WO2018/162150A1 (Casale SA, 13 Sep. 2018) a solution is proposed to overcome the revamping drawbacks. WO2018162150A1 discloses a dual pressure plant for the production of nitric acid comprising a reactor providing a gaseous effluent containing nitrogen oxides, an absorber unit in which nitrogen oxides react with water providing raw nitric acid and, the absorber unit operating at a pressure greater than the pressure of the reactor, a compressor elevating the pressure of the reactor effluent to the absorber unit pressure, the plant also comprising a first HP bleacher unit and a second LP bleacher unit, the first HP bleacher unit stripping with air the NOₓ gas from the output stream of the absorber unit, thus providing a partially stripped nitric acid stream and a nitrogen oxides-loaded air stream, the former being fed to the second LP-bleacher unit and the latter being recycled to the oxidation section, upstream of the NOₓ gas compressor. A further air compressor is also provided, which supplies the first HP bleacher unit with air. Hence, energy is required in order to operate a first HP bleacher unit at a high pressure and then recycle NOₓ gases to the delivery side of the NOₓ gas compressor.

Therefore, there remains a need for a process and a corresponding plant setup for minimizing the amount of energy required in order to operate the air compressor, in order to avoid bottle-necks in the nitric acid production throughput associated with those compressors.

### SUMMARY

In one aspect of the disclosure, a system for producing nitric acid at reduced power consumption is disclosed. The system comprises:
an air compressor for compressing air to a pressure P1, comprising an inlet and an outlet, to provide in a compressed air stream;
a source of pressurized oxygen-rich gas having a pressure higher than P1, such as a high pressure water electrolyzer, in fluid communication with the compressed air stream, to provide in an oxygen-rich gas/compressed air stream mixture;
a mixing apparatus for mixing the oxygen-rich gas/compressed air stream mixture with an ammonia gas stream, optionally pre-heated in a pre-heater, to provide in an ammonia/oxygen-enriched air mixture;
an ammonia converter for oxidising ammonia in the ammonia/oxygen-enriched air mixture, to provide in a NOₓ gas/steam mixture, comprising water and nitric oxide;
means for measuring the temperature in the ammonia converter;
means for regulating the concentration of ammonia and of oxygen in the ammonia converter;
a steam turbine or an electric motor and means for converting steam into electricity, for converting steam into power, in fluid communication with the ammonia converter or the NOₓ/gas steam mixture;
a water cooler/condenser for separating and condensing steam from NOₓ gas in the gaseous NOₓ gas/steam mixture, thereby generating an aqueous diluted nitric acid mixture and a gaseous NOₓ stream;
an absorption tower downstream the water cooler/condenser, for absorbing the NOₓ gases from the gaseous NOₓ stream in water, to provide in a stream of raw nitric acid-containing residual NOₓ gas and a tail gas comprising NOₓ gases, comprising an absorption tower tail gas outlet for evacuating the tail gas; and
a tail gas expander for expanding the tail gas downstream of the absorption tower comprising a tail gas expander inlet in fluid communication with the absorption tower tail gas outlet, and a tail gas expander outlet.

The system is further characterized in that it further comprises:
means for splitting the tail gas into a first tail gas stream directed to the tail gas expander inlet and a second tail gas stream directed to a means for pressurizing, for pressurizing the tail gas stream to a pressure of about P1 in fluid communication with the compressed air stream, to provide in a pressurized tail gas stream joining the compressed air stream; and
means for adjusting the amount of tail gas being split into the first tail gas stream directed to the tail gas expander inlet and the second tail gas stream directed to the means for pressurizing.

The inventors have realized that upon recirculating part of the tail gas to the compressed air stream at a pressure about the pressure P1 of the compressed air stream, downstream the air compressor and upstream the ammonia converter, while at the same time feeding pressurized oxygen to the compressed air stream, and maintaining the temperature in the ammonia converter in the range of 800 to 950° C. and the oxygen to ammonia molar ratio in the ammonia converter between 1.3 and 9, the net power consumption by the compressor train is reduced, considering the reduced power production from the tail gas expander, the compression of the tail gas to P1 and the reduction in power required by the air compressor. Therefore, with the system of the disclosure, power reduction is achieved at the same time as the size of the air compressor and the size of the tail gas expander are reduced, resulting in the reduction of the area footprint of the plant and simplification of the system. Also, the separate supply of the pressurized oxygen or oxygen-rich gas ensures an optimal conversion of ammonia to nitric oxide.

In one embodiment according to the system of the disclosure, the system further comprises a tail gas heater, having an inlet in fluid communication with the absorption tail gas outlet and an outlet in fluid communication with the tail gas expander inlet, positioned upstream from the water cooler/condenser for heating the tail gas coming from the absorption tower to a temperature ranging between 200 to 650° C. with the heat from the NOₓ gas/steam mixture coming from the ammonia converter, and wherein means for splitting the tail gas is positioned upstream from the tail gas heater.

In one embodiment according to the system of the disclosure, the system further comprises a tail gas heater, having an inlet in fluid communication with the absorption tail gas outlet and an outlet in fluid communication with the tail gas expander inlet, positioned upstream from the water cooler/condenser for heating the tail gas coming from the absorption tower to a temperature ranging between 200 to 650° C. with the heat from the NOₓ gas/steam mixture coming from the ammonia converter, and wherein means for splitting the tail gas is positioned downstream from the tail gas heater.

In one embodiment according to the system of the disclosure, the source of pressurized oxygen-rich gas is supplied by a high pressure water electrolyzer.

In one embodiment according to the system of the disclosure, the system further comprises a source of oxygen-rich gas having a pressure at least equal to atmospheric pressure, in fluid communication with the inlet of the air compressor.

In one embodiment according to the system of the disclosure, the system further comprises an additional source of pressurized oxygen-rich gas in fluid communication with an area downstream the absorption tower and upstream the means for pressurizing.

In one embodiment according to the system of the disclosure, the system further comprises a bleacher for bleaching raw nitric acid-containing residual NOₓ gas, comprising an inlet for an oxygen-rich bleaching gas, an inlet for the nitric acid, an outlet for bleached nitric acid and an outlet for bleaching gases, wherein the outlet for the bleaching gases is in fluid communication with the gaseous NOₓ stream.

In another aspect of the disclosure, a method for producing nitric acid at reduced power consumption is disclosed. The method comprises the steps of:
a) compressing air in an air compressor, thereby producing a compressed air stream having a pressure P1;
b) mixing pressurized oxygen-rich gas having a pressure higher than P1 with the compressed air stream, thereby obtaining an oxygen-rich gas/compressed air stream mixture;
c) mixing the oxygen-rich gas/compressed air stream mixture with an ammonia gas stream in a mixing apparatus, thereby producing an ammonia/oxygen-enriched air mixture, such as to achieve an oxygen to ammonia molar ratio ranging from 1.3 to 9;
d) oxidising ammonia in the ammonia/oxygen-enriched air mixture in an ammonia converter at a temperature ranging from 800 to 950° C., thereby producing a gaseous NOₓ gas/steam mixture, comprising water and nitric oxide;
e) converting the steam generated in the ammonia converter or from the gaseous NOₓ gas/steam mixture into power;
f) separating and condensing steam from NOₓ gas in the gaseous NOₓ gas/steam mixture, thereby generating an aqueous diluted nitric acid mixture and a gaseous NOₓ stream, in a water cooler/condenser;
g) absorbing the gaseous NOₓ stream in an absorption tower, thereby producing a stream of raw nitric acid-containing residual NOₓ gas and a tail gas comprising NOₓ gases; and
h) expanding the tail gas in a tail gas expander;

The method is characterized in that it further comprises the steps of:
i) pressurizing part of the tail gas 5 obtained from step g) to a pressure of about P1, thereby generating a pressurized tail gas;
j) mixing the pressurized tail gas with the compressed air stream;
k) measuring the temperature in the ammonia converter; and
I) adjusting the amount of the total gas volume being pressurized in step i) if the temperature measured in step k) is outside the range of 800-950° C., such that the temperature in the ammonia converter is maintained in the range of 800 and 950° C.

In one embodiment according to the method the method further comprises the step of:
m) heating the tail gas obtained in step g) to a temperature ranging from 200 to 650° C. in a tail gas heater positioned upstream from the water cooler/condenser with the heat from the NOₓ gas/steam mixture coming from the ammonia converter.

In one embodiment according to the method of the disclosure, the method further comprises the step of:
m′) heating the tail gas obtained in step g) to a temperature ranging from 200 to 650° C. in a tail gas heater positioned upstream from the water cooler/condenser with the heat from the NOₓ gas/steam mixture coming from the ammonia converter;
   wherein, in step i), part of the tail gas obtained in step g) or in step m′) is pressurized.

In one embodiment according to the method of the disclosure, the method further comprises the step of:
n) operating a high pressure water electrolyzer in order to produce the oxygen gas or oxygen-rich gas used in the mixing step b).

In one embodiment according to the method of the disclosure, the method further comprises the step of:
o) sending an oxygen-rich gas having a pressure at least equal to atmospheric pressure to the inlet of the air compressor.

In one embodiment according to the method of the disclosure, the method further comprises the step of:
p) feeding an additional source of pressurized oxygen-rich gas downstream the absorption tower and upstream the means for compressing.

In one embodiment according to the method of the disclosure, the method further comprises the steps of q) feeding an oxygen-rich bleaching gas to a bleacher for bleaching raw nitric acid-containing residual NOₓ gas; r) bleaching the nitric acid in the bleacher, thereby generating bleached nitric acid and bleaching gases; and s) mixing the bleaching gases with the gaseous NOₓ stream.

In another aspect of the disclosure, the use of the system the disclosure for performing the method of the disclosure is disclosed.

In another aspect of the disclosure, a method for revamping a system or production plant for producing nitric acid is disclosed, wherein the existing system or production plant comprises
an air compressor for compressing air to a pressure P1, comprising an inlet and an outlet, to provide in a compressed air stream;
optionally, a source of pressurized oxygen-rich gas having a pressure higher than the pressure of the compressed air stream, in fluid communication with the compressed air stream, to provide in an oxygen-rich gas/compressed air stream mixture;
a mixing apparatus for mixing the oxygen-rich gas/compressed air stream mixture with an ammonia gas stream, optionally pre-heated in a pre-heater, to provide in an ammonia/oxygen-enriched air mixture;
an ammonia converter for oxidising ammonia in the ammonia/oxygen-enriched air mixture, to provide in a NOₓ gas/steam mixture, comprising water and nitric oxide; means for measuring the temperature in the ammonia converter;
means for regulating the concentration of ammonia and of oxygen in the ammonia converter;
a steam turbine or an electric motor and means for converting steam into electricity, for converting steam into power, in fluid communication with the ammonia converter or the NOₓ/gas steam mixture;
a water cooler/condenser, for separating and condensing steam from NOₓ gas in the gaseous NOₓ gas/steam mixture, thereby generating an aqueous diluted nitric acid mixture and a gaseous NOₓ stream;
an absorption tower downstream the water cooler/condenser, to provide in a stream of raw nitric acid-containing residual NOₓ gas and a tail gas comprising NOₓ gases, comprising an absorption tower tail gas outlet for evacuating the tail gas; and
a tail gas expander for expanding the tail gas downstream of the absorption tower comprising a tail gas expander inlet in fluid communication with the absorption tower tail gas outlet, and a tail gas expander outlet;
   into a system according to the disclosure is disclosed.

The method comprises the steps of:
introducing means for splitting the tail gas into a first tail gas stream directed to the tail gas expander inlet and a second tail gas stream directed to means for pressurizing for pressurizing the second tail gas stream to a pressure of about P1 in fluid communication with the compressed air stream, to provide in a pressurized tail gas stream joining the compressed air stream; and introducing means for adjusting the amount of tail gas being split into the first tail gas stream directed to the tail gas expander inlet and a second tail gas stream directed to means for pressurizing.

### BRIEF DESCRIPTION OF THE FIGURES

FIG. 1 schematically shows a mono pressure nitric acid plant according to the prior art.

FIG. 2A schematically shows an embodiment of a mono-pressure nitric acid plant according to the present disclosure.

FIG. 2B schematically shows an embodiment of a mono-pressure nitric acid plant according to the present disclosure.

FIG. 3 schematically shows an embodiment of the mono-pressure nitric acid plant according to the present disclosure.

FIG. 4 schematically shows an embodiment of the mono-pressure nitric acid plant according to the present disclosure.

List of numerals

| | |
|---|---|
| 4 | Air |
| 5 | tail gas directed to the tail gas expander inlet 8 |
| 6 | outlet of nitric acid absorption tower |
| 7 | tail gas expander |
| 8 | inlet of tail gas expander |
| 9 | outlet of tail gas expander |
| 10 | tail gas stream directed to means for pressurizing 53 |
| 14 | ammonia/oxygen-enriched air mixture |
| 15 | NOₓ gas/steam mixture |
| 17 | aqueous diluted nitric acid mixture |
| 18 | gaseous NOₓ stream |
| 22 | gaseous NOₓ stream |
| 27 | stream of raw nitric acid-containing residual NOₓ gas |
| 32 | ammonia |
| 34 | compressed air |
| 35 | mixing apparatus |
| 36 | air compressor |
| 37 | ammonia converter |
| 38 | water cooler/condenser |
| 39 | cooler/separator |
| 41 | absorption tower |
| 43 | tail gas heater |
| 46 | tail gas heater inlet |
| 47 | tail gas heater outlet |
| 48 | air compressor inlet |
| 49 | air compressor outlet |
| 50 | pressurized oxygen-rich gas stream |
| 51 | steam turbine |
| 52 | pressurized tail gas |
| 53 | means for pressurizing the tail gas stream directed to means for pressurizing 53 |
| 54 | source of oxygen-rich gas having a pressure at least equal to atmospheric pressure |
| 55 | means for splitting the tail gas |
| 56 | oxygen-rich gas/compressed air stream mixture |
| 57 | Bleacher |
| 58 | bleacher inlet for bleaching gas |
| 59 | bleacher outlet for bleached nitric acid |
| 60 | oxygen-rich gas stream |
| 61 | bleaching gases |
| 63 | bleached nitric acid |
| 64 | bleacher inlet for nitric acid |
| 65 | bleacher outlet for bleaching gases |
| 66 | pressurized water electrolyzer |

### DETAILED DESCRIPTION

Throughout the description and claims of this specification, the words “comprise” and variations thereof mean “including but not limited to”, and they are not intended to (and do not) exclude other moieties, additives, components, integers or steps. Throughout the description and claims of this disclosure, the singular encompasses the plural unless the context otherwise requires. In particular, where the indefinite article is used, the disclosure is to be understood as contemplating plurality as well as singularity, unless the context requires otherwise.

Features, integers, characteristics, compounds, chemical moieties, or groups described in conjunction with a particular aspect, embodiment or example of the disclosure are to be understood to be applicable to any other aspect, embodiment or example described herein unless incompatible therewith. All of the features disclosed in this disclosure (including the description, claims, abstract and drawing), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this disclosure (including the description, claims, abstract and drawing), or to any novel one, or any novel combination, of the steps of any method or process so disclosed.

The enumeration of numeric values by means of ranges of figures comprises all values and fractions in these ranges, as well as the cited end points. The terms “in the ranges of” and “ranging from . . . to . . . ” as used when referring to a range for a measurable value, such as a parameter, an amount, a time period, and the like, is intended to include the limits associated to the range that is disclosed.

As defined herein, a pressurized oxygen-rich gas is a gas having a pressure ranging from 9 to 30 bar, preferably 15 to 30 bar, and comprising more than 21 vol % of oxygen, more in particular more than 30 vol %, more than 40 vol %, more than 50 vol %, more than 60 vol %, more than 70 vol %, more than 80 vol %, more than 90 vol %, more than 95 vol %, and more than 99 vol %, more in particular 100 vol % of oxygen.

As defined herein, an oxygen-rich gas is a gas comprising more than 21 vol % of oxygen, more in particular more than 30 vol %, more than 40 vol %, more than 50 vol %, more than 60 vol %, more than 70 vol %, more than 80 vol %, more than 90 vol %, more than 95 vol %, and more than 99 vol %, more in particular 100 vol % of oxygen.

As defined herein, air is ambient air, having a pressure about the atmospheric pressure.

### System for Producing Nitric Acid

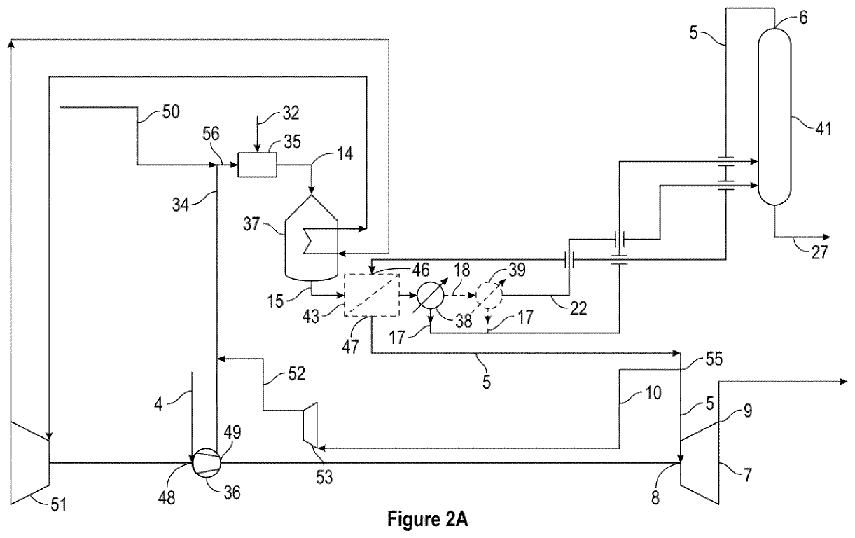

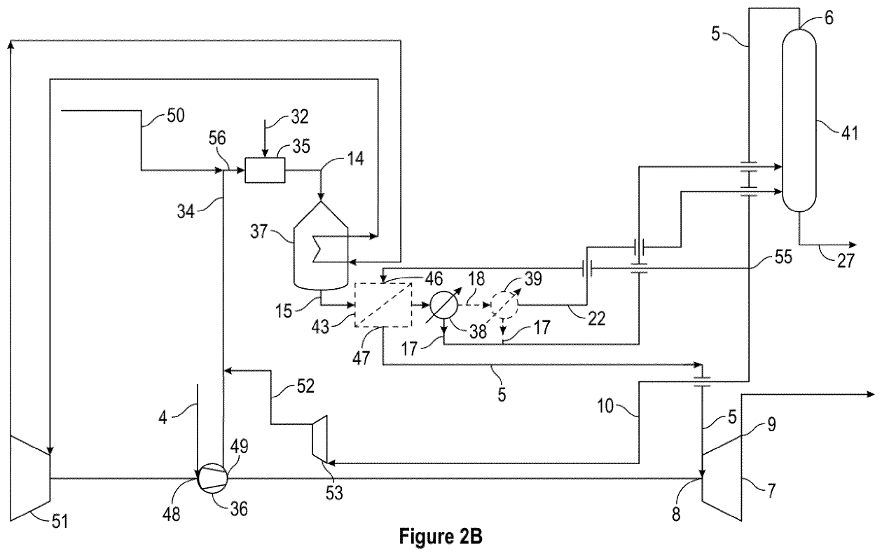

Reference is made to FIGS. 2A and 2B. In one aspect of the disclosure, a system for producing nitric acid at reduced power consumption is disclosed. The system comprises an air compressor 36 for compressing air to a pressure P1, comprising an inlet 48 and an outlet 49, to provide in a compressed air stream 34; a source of pressurized oxygen-rich gas 50 having a pressure higher than the pressure P1, in fluid communication with the compressed air stream 34, to provide in an oxygen-rich gas/compressed air stream mixture 56; a mixing apparatus 35 for mixing the oxygen-rich gas/compressed air stream mixture 56 with an ammonia gas stream 32, optionally pre-heated in a pre-heater, to provide in an ammonia/oxygen-enriched air mixture 14; an ammonia converter 37 for oxidising ammonia in the ammonia/oxygen-enriched air mixture 14, to provide in a NOₓ gas/steam mixture 15, comprising water and nitric oxide; means for measuring (not shown) the temperature in the ammonia converter 37; means for regulating the concentration of ammonia and of oxygen in the ammonia converter 37; a steam turbine 51 or an electric motor (not shown) and means for converting steam into electricity (not shown), for converting steam into power, in fluid communication with the ammonia converter 37 or the NO/gas steam mixture 15; an arrangement of a water cooler/condenser 38, for separating and condensing steam from NOₓ gas in the gaseous NOₓ gas/steam mixture 15, thereby generating an aqueous diluted nitric acid mixture 17 and a gaseous NOₓ stream 22; an absorption tower 41 downstream the water cooler/condenser 38, for absorbing the NOₓ gases from the gaseous NOₓ stream 22 in water, to provide in a stream of raw nitric acid-containing residual NOₓ gas 27 and a tail gas 5 comprising NOₓ gases, comprising an absorption tower tail gas outlet 6 for evacuating the tail gas 5; and a tail gas expander 7 for expanding the tail gas 5 downstream of the absorption tower comprising a tail gas expander inlet 8 in fluid communication with the absorption tower tail gas outlet 6, and a tail gas expander outlet 9.

The system is further characterized in that it further comprises means for splitting 55 the tail gas 5 into a first tail gas stream 5 directed to the tail gas expander inlet 8 and a second tail gas stream 10 directed to means for pressurizing 53 for pressurizing the tail gas stream 10 to a pressure of about P1 in fluid communication with the compressed airstream 34, to provide in a pressurized tail gas stream 52 joining the compressed air stream 34; and means for adjusting the amount of tail gas 5 being split into the first tail gas stream 5 directed to the tail gas expander inlet 8 and the second tail gas stream 10 directed to means for pressurizing 53.

As defined herein, means for regulating the concentration of ammonia and oxygen in the ammonia converter 37 are any suitable means for assessing the amount of ammonia to be introduced in the system from a measure of the oxygen concentration, or the amount of oxygen to be introduced in the system from a measure of the ammonia concentration, such that the oxygen to ammonia molar ratio will range from 1.3 to 9. The oxygen or ammonia concentration can be determined, for example, from a measurement in the gas phase using a process gas analyzer. The oxygen or ammonia concentration can also be determined from computing using the concentration of the oxygen- or ammonia source being introduced in the system, the flow at which the source is introduced in the system, and the relative flow values of the gases at which the gases are mixed. Using the oxygen or ammonia concentration, the relevant flow of ammonia or oxygen respectively to be introduced in the system is, in turn, determined and is used in controlling the flow of ammonia or oxygen, from gaseous sources of ammonia or oxygen respectively at pre-determined concentrations. Controlling of the flow of gaseous ammonia or oxygen can, for example, be achieved through flow control valves. In particular, the means is an integrated process control system, in which the concentration of oxygen or ammonia respectively is measured, and the relevant flow of ammonia or oxygen respectively is thereby determined, thus controlling the flow of ammonia or oxygen, from gaseous sources of ammonia or oxygen respectively at pre-determined concentrations.

As defined herein, means for measuring the temperature are any means suitable for measuring and indicating the temperature in the ammonia oxidation burner. In particular, the means for measuring the temperature is a thermocouple or a thermometer suitable for measuring and indicating a temperature as high as 1000° C. More in particular, the means for measuring the temperature is an infrared thermometer for measuring and indicating a temperature as high as 1000° C.

As defined herein, means for converting steam into power are any mean for achieving power from steam. In particular those means are a steam turbine connected to an electric generator.

As defined herein, means for splitting are any means suitable for splitting the tail gas 5 such as to generate, in addition to the tail gas 5, another gas stream 10 of tail gas directed to the means for pressurizing 53. In particular, the means for splitting is a T-connection having one inlet and two outlets, such that a gas flowing through the inlet of the T-connection is split into two gas streams of identical chemical composition.

As defined herein, means for compressing are any suitable means for increasing the pressure of the tail gas 10 in fluid communication with the compressed air stream 34. In particular, the means for compressing is a gas compressor or a gas ejector through which a motive gas is flowing at a higher velocity than the tail gas 10 in fluid communication with the compressed air stream 34.

As defined herein, means for adjusting the amount of tail gas 5 being split into the first tail gas stream 5 directed to the tail gas expander inlet 8 and the second tail gas stream 10 directed to the means for pressurizing 53, are any means for controlling the splitting in the means for splitting 55. In particular, the means for splitting 55 is a T-connection as described above and the means for adjusting is an orifice or a guide vane or a flow control valve at one or both of the outlets of the T-connection. Even more in particular, the means is an integrated process control system, in which the temperature in the ammonia converter 37 is determined through the means for measuring the temperature. The temperature in the ammonia converter 37 is then used for controlling a flow control valve in the means for splitting 55, thereby controlling the splitting of the tail gas 5, in order for the measured temperature to be maintained in the range of 800 to 950° C.

The inventors have realized that upon recirculating part of the tail gas 5 to the compressed air stream 34, at the pressure P1 of the compressed air stream 34, downstream the air compressor 36 and upstream the ammonia converter 37, while at the same time feeding pressurized oxygen 50, such as provided by a high-pressure electrolyzer, to the compressed air stream 34, and maintaining the temperature in the ammonia converter 37 in the range of 800 to 950° C. and the oxygen to ammonia molar ratio in the ammonia converter 37 between 1.3 and 9, net reduction of the power consumption by the compressor train can be achieved. Albeit the tail gas 5 leaving the absorption tower 41 is less pressurized than the compressed air stream 34 leaving the air compressor 36, the corresponding pressure drop only accounts for 0.5 to 1.5 bar. Consequently, the tail gas 5, whether upstream or downstream the tail gas heater 43, retains a pressure ranging from 1 to 16 bar. Hence, upon pressurizing the tail gas 10 to a pressure about the pressure of the compressed air stream 34 and mixing the pressurized tail gas 52 with the compressed air stream 34, less power is required to provide the necessary total amount of compressed gas to the mixing apparatus 35. By ensuring that the temperature in the burner is maintained in the range of 800 to 950° C., it is ensured that, despite the demand on the means for pressurizing 53 and less power being produced from the tail gas expander 7 due to less tail gas 5 being expanded, a net reduction of the power consumption by the compressor train is retained. In addition, in particular by providing a separate supply of high-pressure oxygen or oxygen-rich gas, it is ensured that the oxygen and ammonia concentrations in the ammonia converter 37 allow for the production of nitric acid of a commercial grade.

In addition to the net saving in the power consumption by the compressor train mentioned above, the inventors have identified that, the recirculation of part of the tail gas 5 results in the temperature of the gaseous NOₓ stream 15 at the outlet of the ammonia converter 37 being such that the heat exchange between the gaseous NOₓ stream 15 and the tail gas 5 is more efficient: hence, in case the tail gas heater is present and the tail gas 5 is heated, the size of the heat exchanger 43 and of the coolers 38 can be decreased. Further, as less tail gas 5 is directed to the tail gas expander and, ultimately, to the atmosphere, the NOₓ emissions arising from the tail gas are reduced.

In one embodiment according to the system of the disclosure, the system further comprises a tail gas heater 43, having an inlet 46 in fluid communication with the absorption tail gas outlet 6 and an outlet 47 in fluid communication with the tail gas expander inlet 8, positioned upstream from the water cooler/condenser 38 for heating the tail gas 5 coming from the absorption tower 41 to a temperature ranging between 200 to 650° C. with the heat from the NOₓ gas/steam mixture 15 coming from the ammonia converter 37, and wherein means for splitting 55 the tail gas 5 is positioned upstream from the tail gas heater 43.

In one embodiment according to the system of the disclosure, the system further comprises a tail gas heater 43, having an inlet 46 in fluid communication with the absorption tail gas outlet 6 and an outlet 47 in fluid communication with the tail gas expander inlet 8, positioned upstream from the water cooler/condenser 38 for heating the tail gas 5 coming from the absorption tower 41 to a temperature ranging between 200 to 650° C. with the heat from the NOₓ gas/steam mixture 15 coming from the ammonia converter 37, and wherein means for splitting 55 the tail gas 5 is positioned downstream from the tail gas heater 43.

The person skilled in the art will understand that this is possible to compress either one of the tail gas 5 or the heated tail gas 5 in fluid communication with the tail expander inlet 8 or a mixture thereof.

The choice of the point from which the tail gas 5 is recirculated, that is upstream or downstream the tail gas heater 43, influences the temperature of the gas mixture 14, and thereby, the efficiency of the combustion in the burner. The system of the disclosure provides the necessary flexibility for the person skilled in the art to choose where to recirculate the tail gas 5 from. Thereby, he/she can achieve the optimal temperature for the gas mixture 14, depending on parameters including, for example, the gas volume flown to or the catalyst present in the converter 37, as well as the ratio of oxygen to ammonia in the gas mixture 14.

In one embodiment according to the system of the disclosure, the source of pressurized oxygen-rich gas 50 is supplied by a high pressure water electrolyzer. Stated differently, in particular embodiments, the system of the present disclosure comprises a high-pressure water electrolyzer, wherein the high-pressure water electrolyzer, in particular its anode, is in fluid communication with the compressed air stream, to provide an oxygen-rich gas/compressed air stream mixture.

A water electrolyzer is a device for the electrolysis of water, being the decomposition of water into oxygen and hydrogen gas, due to the passage of an electric current therethrough. This technique can be used to make hydrogen gas, a main component of hydrogen fuel, and oxygen gas. A suitable high pressure water electrolyzer may comprise an anode producing oxygen gas according to the reaction

2OH−=H₂O+½O₂+2e−;

a cathode, producing hydrogen gas according to the reaction

2H₂O+2e−=H₂+2OH−;

an electrolyte consisting of an alkaline solution such as potassium hydroxide; and a porous diaphragm separating the anode and the cathode, in order to avoid the mixing of hydrogen gas and oxygen gas that together form an explosive mixture. Alternatively, the anode and the cathode may be separated by a solid polymer electrolyte such as the fluoropolymer Nafion, where the electrolyte provides the selective transport of protons from the anode to the cathode, as well as the electrical insulation between the anode and the cathode, and avoids the mixing of hydrogen gas and oxygen gas that together form an explosive mixture. The anode and cathode can be made of nickel or steel, or mixtures thereof. Alternatively, for the purpose of enhancing the electrode reactions, the anode and cathode may contain catalysts that can be made of Iridium and Platinum, respectively. The diaphragm of an electrically insulating material is based on, for example, zirconia. The diaphragm has a porosity such that it forms a barrier against transport of hydrogen and oxygen gas bubbles, while containing a continuum of penetrated liquid electrolyte. An anode-diaphragm-cathode assembly constitutes an electrolysis cell. Electrolysis cells are piled in series in stacks that compose the core of an electrolyzer. The hydrogen and oxygen production for a given stack volume is proportional to the current density and inversely proportional to the stacking distance. Regardless of stack volume, the hydrogen and oxygen production is proportional to the total current. In addition to the stack, the electrolyzer comprises auxiliaries such as a current rectifier, a water demineralization unit, a water pump and a cooling system, a hydrogen purification unit, and instrumentation.

The electrolyzer is operated by applying a voltage corresponding to the standard potential plus the overpotential over each cell. The total voltage depends on the total number of cells of which the electrolyzer is comprised. OH— ions generated at the cathode migrate through the electrolyte in the diaphragm to the anode, where they are consumed by the anode reaction. Electrons travel the opposite direction in an external circuit. The electrolyzer may be operated at a temperature of 50 to 80° C., or 60 to 80° C., and a gas pressure of 9 to 30 bar, preferably 15 to 30 bar.

A high pressure water electrolyzer hence results in the production of pressurized hydrogen at the cathode and pressurized oxygen at the anode. What is required to perform high pressure electrolysis is to pressurize the water used in the electrolysis process. As pressurizing water requires less power than pressuring a gas, the use of a high pressure water electrolyzer results in the production of pressurized oxygen-rich gas 50 at minimized power consumption.

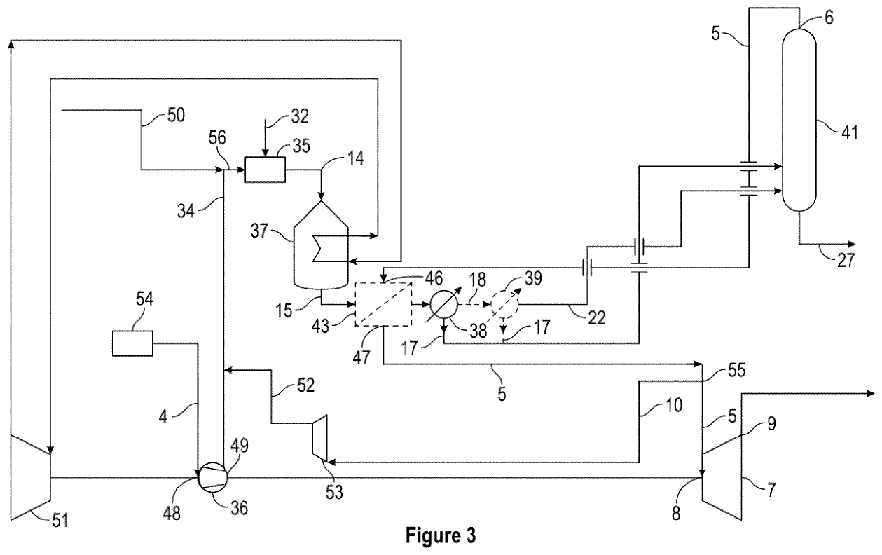

Reference is made to FIG. 3. In one embodiment according to the system of the disclosure, the system further comprises a source of oxygen-rich gas 54 having a pressure at least equal to atmospheric pressure, in fluid communication with the inlet 48 of the air compressor 36.

The presence of the source of oxygen-rich gas 54 implies that less air is to be pressurized in order to achieve the content of oxygen achieved in the prior art process at the outlet of the air compressor 36. As a result, the power demand on the air compressor 36 is reduced.

Reference is made to FIGS. 2A, 2B and 3. In one embodiment according to the system of the disclosure, the system further comprises an additional source of pressurized oxygen-rich gas (not shown) in fluid communication with an area downstream the absorption tower 41 and upstream the means for pressurizing 53.

The oxygen-rich gas can be fed either upstream or downstream the means for splitting 55. When oxygen-rich gas from such additional source is fed downstream the absorption tower 41, less air is to be pressurized in order to achieve the content of oxygen achieved in the prior art process at the outlet of the air compressor 36. As a result, the power demand on the air compressor 36 is reduced. Further, additional power will be generated through the tail gas expander 7. In addition, the power demand on the means for pressuring 53 is decreased, in particular if the oxygen-rich gas from such additional source is provided by a high pressure water electrolyzer, producing pressurized oxygen-rich gas at less power than through pressurizing oxygen gas, as pressurizing the water being electrolyzed in the electrolyzer consumes less power than pressurizing a gas.

In addition, additional pressurized oxygen-rich gas may be supplied upstream the absorption tower, which improves the absorption of NOₓ gases in the absorption tower, which, in its turn, results in additional nitric acid production and reduction of the emissions to the atmosphere. In addition, or alternatively, the size of the absorption tower 41 can be reduced.

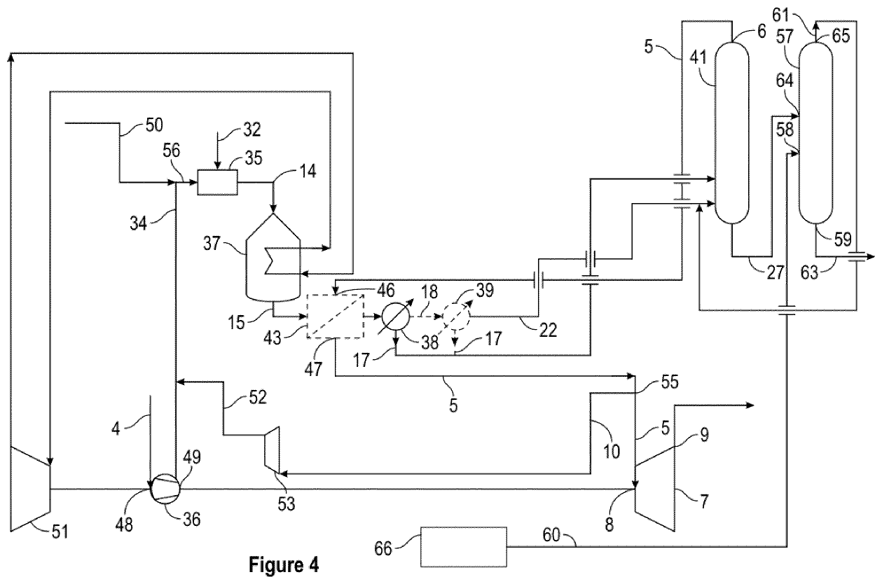

Reference is made to FIG. 4. In one embodiment according to the system of the disclosure, the system further comprises a bleacher 57 for bleaching raw nitric acid-containing residual NOₓ gas, comprising an inlet 58 for an oxygen-rich bleaching gas 60, an inlet 64 for the stream of raw nitric acid-containing residual NOₓ gas 27, an outlet 59 for bleached nitric acid 63 and an outlet 65 for bleaching gases 61, wherein the outlet 65 for the bleaching gases 61 is in fluid communication with the gaseous NOₓ stream 22.

In this way, an efficient use of an oxygen-rich bleaching gas is made to increase the oxygen content in the absorption tower 41, thereby increasing the absorption of the NOₓ gases and reducing the corresponding emissions to air. In particular, the oxygen-rich bleaching gas 60 is provided by a high pressure water electrolyzer 66: as less energy is required to pressurize water than to pressurize oxygen gas, pressurized oxygen gas is obtained at minimum power consumption. The person skilled in the art will understand that the pressure of the bleaching gas 60 must be such that upon recirculating the bleaching gases 61 to the absorption tower 41, the pressure in the absorption tower 41 is about the pressure in the ammonia converter 37. Consequently, depending upon the pressure at which the water electrolyzer 66 is operated, the pressure can be adjusted and decreased accordingly with means conventional in the state-of-the art, for example pressure regulating valves (not shown). In addition, less secondary air must be compressed and supplied by the air compressor 36 to the bleacher 57, which results in savings in the power demand by the air compressor 36. Advantageously, the pressurized oxygen-rich gas produced by the high pressure water electrolyzer 66 can be the source of all streams 50, 54, and 66.

### Method for Producing Nitric Acid

In another aspect of the disclosure, a method for producing nitric acid at reduced power consumption is disclosed. The method comprises the steps of a) compressing air in an air compressor 36, thereby producing a compressed air stream 34 having a pressure P1; b) mixing pressurized oxygen-rich gas 50 having a pressure higher than P1 with the compressed air stream 34, thereby obtaining an oxygen-rich gas/compressed air stream mixture 56; c) mixing the oxygen-rich gas/compressed air stream mixture 56 with an ammonia gas stream 32 in a mixing apparatus 35, thereby producing an ammonia/oxygen-enriched air mixture 14, such as to achieve an oxygen to ammonia molar ratio ranging from 1.3 to 9; d) oxidising ammonia in the ammonia/oxygen-enriched air mixture 14 in an ammonia converter 37 at a temperature ranging from 800 to 950° C., thereby producing a gaseous NOₓ gas/steam mixture 15, comprising water and nitric oxide; e) converting the steam generated in the ammonia converter 37 or from the gaseous NOₓ gas/steam mixture 15 into power; f) separating and condensing steam from NOₓ gas in the gaseous NOₓ gas/steam mixture 15, thereby generating an aqueous diluted nitric acid mixture 17 and a gaseous NOₓ stream 22, in a water cooler/condenser 38; g) absorbing the gaseous NOₓ stream 22 in an absorption tower 41, thereby producing a stream of raw nitric acid-containing residual NOₓ gas 27 and a tail gas 5 comprising NOₓ gases; and h) expanding the tail gas 5 or the heated tail gas 5 in a tail gas expander 7;

The method is characterized in that it further comprises the steps of i) pressurizing part of the tail gas 5 obtained from step g) obtained from the combination step g) and step h) to a pressure about P1, thereby generating a pressurized tail gas 52; j) mixing the pressurized tail gas 52 with the compressed air stream 34; k) measuring the temperature in the ammonia converter 37; and I) adjusting the amount of the total gas volume being pressurized in step i) if the temperature measured in step k) is outside the range of 800-950° C., such that the temperature in the ammonia converter is maintained in the range of 800 to 950° C.

The inventors have realized that upon recirculating part of the tail gas 5 to the compressed air stream 34, at the pressure P1 of the compressed air stream 34, downstream the air compressor 36 and upstream the ammonia converter 37, while at the same time feeding pressurized oxygen 50 to the compressed airstream 34, and maintaining the temperature in the ammonia converter 37 in the range of 800 to 950° C. and the oxygen to ammonia molar ratio in the ammonia converter 37 between 1.3 and 9, net reduction in the power consumption by the compressor train can be achieved. Albeit the tail gas 5 leaving the absorption tower 41 is less pressurized than the compressed air stream 34 leaving the air compressor 36, the corresponding pressure drop only accounts for 0.5 to 1.5 bar. Consequently, the tail gas 5, whether upstream or downstream the tail gas heater 43, retains a pressure ranging from 1 to 16 bar. Hence, upon pressurizing the tail gas 10 to a pressure about P1 and mixing the pressurized tail gas 52 with the compressed air stream 34, less power is required to provide the necessary total amount of compressed gas to the mixing apparatus 35. By ensuring that the temperature in the burner is maintained in the range of 800 to 950° C., it is ensured that, despite the demand on the means for pressurizing 53 and less power being produced from the tail gas expander 7 due to less tail gas 5 being expanded, a net power reduction consumption by the compressor train is retained. In addition, it is ensured that the oxygen and ammonia concentrations in the ammonia converter 37 allow for the production concentrated acid of commercial grade.

In addition to the net saving in the power consumption by the compressor train mentioned above, the inventors have identified that, the recirculation of part of the tail gas 5 results in the temperature of the gaseous NOₓ stream 15 at the outlet of the ammonia converter 37 being such that the heat exchange between the gaseous NOₓ stream 15 and the tail gas 5 is more efficient: hence, in case the tail gas heater is present and the tail gas 5 is heated, the size of the heat exchanger 43 and of the coolers 38 can be decreased. Further, as less tail gas 5 is directed to the tail gas expander and, ultimately, to the atmosphere, the NOₓ emissions arising from the tail gas are reduced.

In one embodiment according to the method of the disclosure, the method further comprises the step of m) heating the tail gas 5 obtained in step g) to a temperature ranging from 200 to 650° C. in a tail gas heater 43 positioned upstream from the water cooler/condenser 38 with the heat from the NOₓ gas/steam mixture 15 coming from the ammonia converter 37.

In one embodiment according to the method of the disclosure, the method further comprises the step of m′) heating the tail gas 5 obtained in step g) to a temperature ranging from 200 to 650° C. in a tail gas heater 43 positioned upstream from the water cooler/condenser 38 with the heat from the NOₓ gas/steam mixture 15 coming from the ammonia converter 37, wherein, in step i), part of the tail gas 5 obtained in step g) or in step m′) is pressurized.

The person skilled in the art will understand that this is possible to compress either one of the tail gas 5 or the heated tail gas 5 in fluid communication with the tail expander inlet 8 or a mixture thereof.

The choice of the point from which the tail gas 5 is recirculated, that is upstream or downstream the tail gas heater 43, influences the temperature of the gas mixture 14, and thereby, the efficiency of the combustion in the burner. The system of the disclosure provides the necessary flexibility for the person skilled in the art to choose where to recirculate the tail gas 5 from. Thereby, he/she can achieve the optimal temperature for the gas mixture 14, depending on parameters including, for example, the gas volume flown to or the catalyst present in the converter 37, as well as the ratio of oxygen to ammonia in the gas mixture 14.

In one embodiment according to the method of the disclosure, the method further comprises the step of n) operating a high pressure water electrolyzer in order to produce the oxygen gas or oxygen-rich gas 50 used in the mixing step b).

A high pressure water electrolyzer hence results in the production of pressurized hydrogen at the cathode and pressurized oxygen at the anode. What is required to perform high pressure electrolysis is to pressurize the water used in the electrolysis process. As pressurizing water requires less power than pressuring a gas, the use of a high pressure water electrolyzer results in the production of pressurized oxygen-rich gas 50 at minimized power consumption. Mixing step b) may thus comprise the steps of operating a high pressure water electrolyzer, such as at a temperature of 50 to 80° C., or 60 to 80° C., and a gas pressure of 9 to 30 bar, preferably 15 to 30 bar, thereby producing a pressurized oxygen or oxygen-rich gas 50 having a pressure higher than P1, and mixing the pressurized oxygen or oxygen-rich gas 50 with the compressed air stream 34.

In one embodiment according to the method of the disclosure, the method further comprises the step of o) sending an oxygen-rich gas having a pressure at least equal to atmospheric pressure 54 to the inlet 48 of the air compressor 36.

The presence of the source of oxygen-rich gas 54 implies that less air is to be pressurized in order to achieve the content of oxygen achieved in the prior art process at the outlet of the air compressor 36. As a result, the power demand on the air compressor 36 is reduced.

In one embodiment according to the method of the disclosure, the method further comprises the step of p) feeding a source of pressurized oxygen-rich gas downstream the absorption tower 41 and upstream the means for compressing 53. In particular, the pressurized oxygen or oxygen-rich gas may be produced by operating a high pressure electrolyzer.

The oxygen-rich gas can be fed either upstream or downstream the means for splitting 55. When oxygen-rich gas from such additional source is fed downstream the absorption tower 41, less air is to be pressurized in order to achieve the content of oxygen achieved in the prior art process at the outlet of the air compressor 36. As a result, the power demand on the air compressor 36 is reduced. Further, additional power will be generated through the tail gas expander 7. In addition, the power demand on the means for pressuring 53 is decreased, in particular if the oxygen-rich gas from such additional source is provided by a high pressure water electrolyzer, producing pressurized oxygen-rich gas at less power than through pressurizing oxygen gas, as pressurizing the water being electrolyzed in the electrolyzer consumes less power than pressurizing a gas.

Reference is made to FIG. 4. In one embodiment according to the method of the disclosure, the method further comprises the steps of q) feeding oxygen-rich gas as the bleaching gas 60 to a bleacher 57 for bleaching raw nitric acid-containing residual NOₓ gas 27; r) bleaching the nitric acid 62 in the bleacher 57, thereby generating bleached nitric acid 63 and bleaching gases 61; and s) mixing the bleaching gases 61 with the gaseous NOₓ stream 22.

In this way, an efficient use of an oxygen-rich bleaching gas is made to increase the oxygen content in the absorption tower 41, thereby increasing the absorption of the NOₓ gases in step g) and reducing the corresponding emissions to air. In particular, the oxygen-rich bleaching gas 60 is provided by a high pressure water electrolyzer 66: as less energy is required to pressurize water than to pressurize oxygen gas, pressurized oxygen gas is obtained at minimum power consumption. The person skilled in the art will understand that the pressure of the bleaching gas 60 must be such that upon recirculating the bleaching gases 61 to the absorption tower 41, the pressure in the absorption tower 41 is about the pressure in the ammonia converter 37. Consequently, depending upon the operating pressure of the water electrolyzer 66, the pressure can be adjusted and decreased accordingly with means conventional in the state-of-the art, for example pressure regulating valves (not shown). In addition, less secondary air must be compressed and supplied by the air compressor 36 to the bleacher 57, which results in savings in the power demand by the air compressor 36. Advantageously, the pressurized oxygen-rich gas produced by the high pressure water electrolyzer 66 can be the source of all streams 50, 54, and 66.

### Use of the System of the Disclosure

In another aspect of the disclosure, the use of the system the disclosure for performing the method of the disclosure is disclosed.

### Method for Revamping a System for Producing Nitric Acid

In another aspect of the disclosure, a method for revamping a system for producing nitric acid comprising an air compressor 36 for compressing air to a pressure P1, comprising an inlet 48 and an outlet 49, to provide in a compressed air stream 34; optionally a source of pressurized oxygen-rich gas 50 having a pressure higher than the pressure of the compressed air stream 34, in fluid communication with the compressed air stream 34, to provide in an oxygen-rich gas/compressed air stream mixture 56; a mixing apparatus 35 for mixing the oxygen-rich gas/compressed air stream mixture 56 with an ammonia gas stream 32, optionally pre-heated in a pre-heater, to provide in an ammonia/oxygen-enriched air mixture 14; an ammonia converter 37 for oxidising ammonia in the ammonia/oxygen-enriched air mixture 14, to provide in a NOₓ gas/steam mixture 15, comprising water and nitric oxide; means for measuring (not shown) the temperature in the ammonia converter 37; means for regulating the concentration of ammonia and of oxygen in the ammonia converter 37; a steam turbine 51 or an electric motor and means for converting steam into electricity, for converting steam into power, in fluid communication with the ammonia converter 37 or the NOₓ/gas steam mixture 15; a water cooler/condenser 38, for separating and condensing steam from NOₓ gas in the gaseous NOₓ gas/steam mixture 15, thereby generating an aqueous diluted nitric acid mixture 17 and a gaseous NOₓ stream 22; an absorption tower 41 downstream the water cooler/condenser 38, for absorbing NOₓ gases in water, to provide in a stream of raw nitric acid-containing residual NOₓ gas 27 and a tail gas 5 comprising NOₓ gases, comprising an absorption tower tail gas outlet 6 for evacuating the tail gas 5; and a tail gas expander 7 for expanding the tail gas downstream of the absorption tower comprising a tail gas expander inlet 8 in fluid communication with the absorption tower tail gas outlet 6, and a tail gas expander outlet 9;

into a system according to the disclosure is disclosed.

The method comprises the steps of introducing means for splitting 55 the tail gas 5 into a first tail gas stream 5 directed to the tail gas expander inlet 8 and a second tail gas stream 10 directed to means for pressurizing 53 for pressurizing the tail gas stream 10 to a pressure of about P1 in fluid communication with the compressed air stream 34, to provide in a pressurized tail gas stream 52 joining the compressed air stream 34; and introducing means for adjusting the amount of tail gas 5 being split into the first tail gas stream 5 directed to the tail gas expander inlet 8 and a second tail gas stream 10 directed to means for pressurizing 53. In certain embodiments, in case the existing system does not comprise a source of pressurized oxygen-rich gas, the revamping method further comprises the step of introducing a source of pressurizing oxygen-rich gas 50, such as a high pressure electrolyzer, said pressurized oxygen rich gas having a pressure higher than the pressure of the compressed airstream 34, and fluidly connecting the source of pressurized oxygen-rich gas with the compressed air stream 34, to provide in an oxygen-rich gas/compressed air stream mixture 56.

As defined herein, means for adjusting the concentration of ammonia and oxygen in the ammonia converter 37 are any suitable means for assessing the amount of ammonia to be introduced in the system from a measure of the oxygen concentration, or the amount of oxygen to be introduced in the system from a measure of the ammonia concentration, such that the oxygen to ammonia molar ratio will range from 1.3 to 9. The oxygen or ammonia concentration can be determined, for example, from a measurement in the gas phase using a process gas analyzer. The oxygen or ammonia concentration can also be determined from computing using the concentration of the oxygen- or ammonia source being introduced in the system, the flow at which the source is introduced in the system, and the relative flow values at which the gases is mixed. Using the oxygen or ammonia concentration, the relevant flow of ammonia or oxygen respectively to be introduced in the system is, in turn, determined and is used in controlling the flow of ammonia or oxygen, from gaseous sources of ammonia or oxygen respectively at pre-determined concentrations. Controlling of the flow of gaseous ammonia or oxygen can, for example, be achieved through flow control valves. In particular, the means is an integrated process control system, in which the concentration of oxygen or ammonia respectively is measured, and the relevant flow of ammonia or oxygen respectively is thereby determined, thus controlling the flow of ammonia or oxygen, from gaseous sources of ammonia or oxygen respectively at pre-determined concentrations.

As defined herein, means for measuring the temperature are any means suitable for measuring and indicating the temperature in the ammonia oxidation burner. In particular, the means for measuring the temperature is a thermocouple or a thermocouple or a thermometer suitable for measuring and indicating a temperature as high as 1000° C. More in particular, the means for measuring the temperature is an infrared thermometer for measuring and indicating a temperature as high as 1000° C.

As defined herein, means for converting steam into power are any mean for achieving power from steam. In particular those means are a steam turbine connected to an electric generator.

As defined herein, means for splitting are any means suitable for splitting the tail gas 5 such as to generate, in addition to the tail gas 5, another gas stream 10 of tail gas directed to the means for pressurizing 53. In particular, the means for splitting is a T-connection having one inlet and two outlets, such that a gas flowing through the inlet of the T-connection is split into two gas streams of identical chemical composition.

As defined herein, means for compressing are any suitable means for increasing the pressure of the tail gas 10 in fluid communication with the compressed air stream 34. In particular, the means for compressing is a gas compressor or a gas ejector through which a motive gas is flowing at a higher velocity than the tail gas 10.

As defined herein, means for adjusting the amount of tail gas 5 being split into the first tail gas stream 5 directed to the tail gas expander inlet 8 and the second tail gas stream 10 directed to the means for pressurizing 53, are any means for controlling the splitting in the means for splitting 55. In particular, the means for splitting 55 is a T-connection as described above and the means for adjusting is an orifice or a guide vane or a flow control valve at one or both of the outlets of the T-connection. Even more in particular, the means is an integrated process control system, in which the temperature in the ammonia converter 37 is determined through the means for measuring the temperature. The temperature in the ammonia converter 37 is then used for controlling a flow control valve in the means for splitting 55, thereby controlling the splitting of the tail gas 5, in order for the measured temperature to be maintained in the range of 800-950° C.

### Examples

### 1. Recirculation of Tail-Gas at 40%

Reference is made to FIG. 2A. Ambient air 4 was compressed in an air compressor 36, generating the compressed air stream 34. Pressurized oxygen-rich gas 50 at a pressure of 8 bar was mixed with the compressed air stream 34, thereby producing an oxygen-rich gas/compressed air stream mixture 56. Ammonia 32 was mixed with the oxygen-rich gas/compressed air stream mixture 56 in a mixing apparatus 35, such as to achieve an oxygen to ammonia molar ration ranging from 1.3 to 9. The resulting ammonia/oxygen-enriched air mixture 14 was fed to an ammonia converter 37, at a temperature ranging from 800 to 950° C. and operating at a pressure of 6.2 bar. In the ammonia converter 37, ammonia was oxidized over a mixed platinum/rhodium catalyst, thus obtaining a NOₓ gas/steam mixture 15, comprising water and nitric oxide (NO). The heat of the mixture coming out of the ammonia converter was recovered using the steam turbine 51 and also by heating the tail gas 5 as will be described below. The NOₓ gas/stream mixture was subsequently cooled down in a water cooler/condenser 38 to temperature where the water condenses, and an aqueous diluted nitric acid mixture 17 was separated from a gaseous NOₓ stream 18. Subsequently, the gaseous NOₓ stream was further oxidized to further convert the NO to NO₂ and N₂O₄, and cooled down again in a cooler/separator 39 to separate out another aqueous diluted nitric acid mixture 17 which was directed to an absorption tower 41. On the other end, the gaseous NOₓ stream 22 was sent to the absorber unit 6 too. Inside the absorber unit 6, the NOₓ gas reacted with water to produce the tail gas 5 and a stream of raw nitric acid also containing residual NOₓ gas, which was fed to a bleacher (not shown). The heat from the gaseous NOₓ stream 15 was used for heating the tail gas 5 in the tail gas heater 43 to 450° C. The heated tail gas stream 5 was split over a T-tube, such that 40% of the heated tail gas 5 was split, thereby producing the heated tail gas 10. The heated tail gas 10 was pressurized using an additional gas compressor 53, then mixed with the compressed air stream 34. The temperature inside the ammonia converter 37 was measured and established to have remained in the range of 800 to 950° C. The residual 60% of tail gas was sent to the tail gas expander 7. The residual NOₓ gas in the raw nitric acid stream 27 was then stripped out with a gaseous medium (not shown) such as an oxygen-containing gas or air, inside the bleacher unit (not shown); the bleacher unit was generally operated at about the same pressure as the ammonia converter of 6.2 bar. The drive power for the air compressor 36 and the gas compressor 53 originated from the tail gas expander 7 and the steam turbine 51. The net power associated to the air compressors 36 and 53 and the tail gas expander 7 and the steam turbine 51 was 77 kW/h/t 100% HNO₃. This power was provided by the steam turbine 51.

### 2. Recirculation of Tail-Gas at 65% and Addition of Oxygen to the Air Compressor

Reference is made to FIG. 3. Oxygen enriched air 54 and ambient air 32 were compressed in an air compressor 36, generating the stream 34. Pressurized oxygen-rich gas 50 at a pressure of 8 bar was mixed with the compressed air stream 34, thereby producing an oxygen-rich gas/compressed air stream mixture 56. Ammonia 32 was mixed with the oxygen-rich gas/compressed air stream mixture 56 in a mixing apparatus 35, such as to achieve an oxygen to ammonia molar ration ranging from 1.3 to 9. The resulting ammonia/oxygen-enriched air mixture 14 was fed to an ammonia converter 37, at a temperature ranging from 800 to 950° C. and operating at a pressure of 6.2 bar. In the ammonia converter 37, ammonia was oxidized over a mixed platinum/rhodium catalyst, thus obtaining a NOₓ gas/steam mixture 15, comprising water and nitric oxide (NO). The heat of the mixture coming out of the ammonia converter was recovered using the steam turbine 51 and also by heating the tail gas 5 as will be described below. The NOx gas/stream mixture was subsequently cooled down in a water cooler/condenser 38 to temperature where the water condenses, and an aqueous diluted nitric acid mixture 17 was separated from a gaseous NOₓ stream 18. Subsequently, the LP gaseous NOₓ stream was further oxidized to further convert the NO to NO₂ and N₂O₄, and cooled down again in a cooler/separator 39 to separate out another aqueous diluted nitric acid mixture 17 which was directed to an absorption tower 41. On the other end, the gaseous NOₓ stream 22 was sent to the absorber unit 6 too. Inside the absorber unit 6, the NOₓ gas reacted with water to produce the tail gas 5 and a stream of raw nitric acid also containing residual NOₓ gas, which was fed to a bleacher (not shown). The heat from the gaseous NOₓ stream 15 was used for heating the tail gas 5 in the tail gas heater 43 to 450° C. The heated tail gas stream 5 was split over a T-tube, such that 65% of the heated tail gas 5 was split, thereby producing the heated tail gas 10. The heated tail gas 10 was pressurized using an additional gas compressor 53, then mixed with the compressed air stream 34. The temperature inside the ammonia converter 37 was measured and established to have remained in the range of 800 to 950° C. The residual 35% of tail gas was sent to the tail gas expander 7. The residual NOₓ gas in the raw nitric acid stream 27 was then stripped out with a gaseous medium (not shown) such as an oxygen-containing gas or air, inside the bleacher unit (not shown), operated at about the same pressure as the ammonia converter of 6.2 bar. The drive power for both the air compressor 36 and the gas compressor 53 originated from the tail gas expander 7 and the steam turbine 51. The net power associated to the air compressor 36, the compressor 53 and the tail gas expander 7 was 68 kWh/t 100% HNO₃. This power was produced by the steam turbine 51.

### 3. Comparative Example: No Recirculation of Tail-Gas

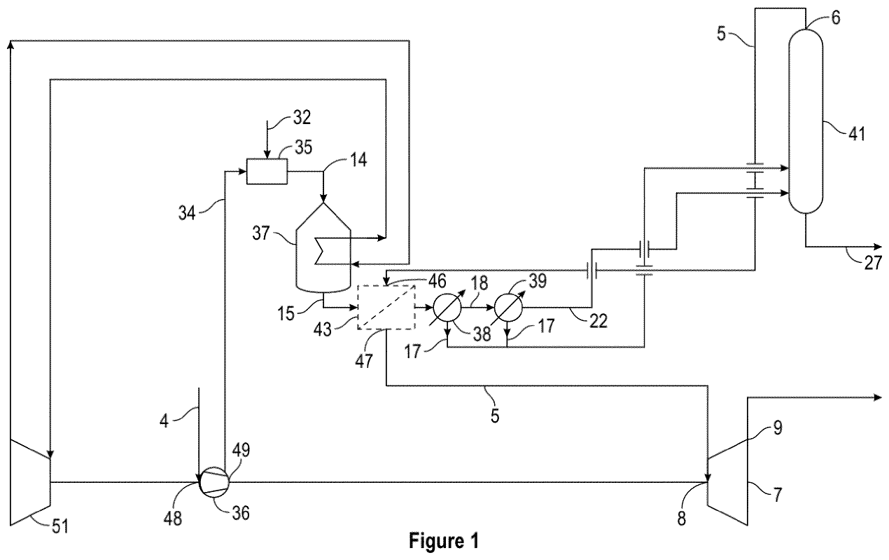

Reference is made to FIG. 1. Ambient air 4 was compressed in an air compressor 36, generating the compressed air stream 34. Pressurized oxygen-rich gas 50 at a pressure of 8 bar was mixed with the compressed air stream 34, thereby producing an oxygen-rich gas/compressed air stream mixture 56. Ammonia 32 was mixed with the oxygen-rich gas/compressed air stream mixture 56 in a mixing apparatus 35, such as to achieve an oxygen to ammonia molar ration ranging from 1.3 to 9. The resulting ammonia/oxygen-enriched air mixture 14 was fed to an ammonia converter 37, operating at a pressure of 5.2 bar. In the ammonia converter 37, ammonia was oxidized over a mixed platinum/rhodium catalyst, thus obtaining a low-pressure NOx gas/steam mixture 15, comprising water and nitric oxide (NO). The heat of the mixture coming out of the ammonia converter was recovered using the steam turbine 51 and also by heating the tail gas 5 as will be described below. The NOx gas/stream mixture was subsequently cooled down in a water cooler/condenser 38 to temperature where the water condenses, and an aqueous diluted nitric acid mixture 17 was separated from a gaseous NOx stream 18. Subsequently, the LP gaseous NOx stream was further oxidized to further convert the NO to NO₂ and N₂O₄, and cooled down again in a cooler/separator 39 to separate out another aqueous diluted nitric acid mixture 17 which was directed to an absorption tower 41. On the other end, the gaseous NOx stream 22 was sent to the absorber unit 6 too. Inside the absorber unit 6, the high pressure NOx gas reacted with water to produce the tail gas 5 and a stream of raw nitric acid also containing residual NOx gas, which was fed to a bleacher (not shown). The heat from the gaseous NOx stream 15 was used for heating the tail gas 5 in the tail gas heater 43 to 450° C. The entire tail gas stream 5 was sent to the tail gas expander 7. The residual NOx gas in the raw nitric acid stream 27 was then stripped out with a gaseous medium (not shown) such as an oxygen-containing gas or air, inside the bleacher unit (not shown); the bleacher unit was generally operated at about the same pressure as the ammonia converter, of 5.2 bar. The drive power for the air compressor 36 originated from the tail gas expander 7 and the steam turbine 51. The net power associated to the air compressor 36, and the tail gas expander 7 was 153 kW/h/t 100% HNO₃. This power was produced by the steam turbine 51.

Therefore, when compared to the example 1, a net power of 76 kWh/t 100% HNO₃ (50%) was saved upon recirculating 40% of the tail gas.

Therefore, when compared to the example 2, a net power of 85 kWh/t 100% HNO₃ (55%) was saved upon recirculating 65% of the tail gas.

1. A system for producing nitric acid at reduced power consumption, comprising:
an air compressor for compressing air to a pressure P1, comprising an inlet and an outlet, to provide in a compressed air stream;
a source of pressurized oxygen-rich gas having a pressure higher than P1, in fluid communication with the compressed air stream, to provide in an oxygen-rich gas/compressed air stream mixture;
a mixing apparatus for mixing the oxygen-rich gas/compressed air stream mixture with an ammonia gas stream, to provide in an ammonia/oxygen-enriched air mixture;
an ammonia converter for oxidising ammonia in the ammonia/oxygen-enriched air mixture, to provide in a NOₓ gas/steam mixture, comprising water and nitric oxide;
means for measuring a temperature in the ammonia converter;
means for regulating a concentration of ammonia and of oxygen in the ammonia converter;
a steam turbine or an electric motor and means for converting steam into power, in fluid communication with the ammonia converter or the NOₓ gas/steam mixture;
a water cooler/condenser for separating and condensing steam from NOₓ gas in the NOₓ gas/steam mixture, to provide in an aqueous diluted nitric acid mixture and a gaseous NOₓ stream;
an absorption tower downstream the water cooler/condenser, for absorbing the NOₓ gases from the gaseous NOₓ stream in water, to provide in a stream of raw nitric acid-containing residual NOₓ gas and a tail gas comprising NOₓ gases, comprising an absorption tower tail gas outlet for evacuating the tail gas; and
a tail gas expander for expanding the tail gas downstream of the absorption tower comprising a tail gas expander inlet in fluid communication with the absorption tower tail gas outlet, and a tail gas expander outlet;
characterized in that the system further comprises:
means for splitting the tail gas into a first tail gas stream directed to the tail gas expander inlet and a second tail gas stream directed to means for pressurizing for pressurizing the tail gas stream to a pressure of about P1 in fluid communication with the compressed air stream, to provide in a pressurized tail gas stream joining the compressed air stream; and
means for adjusting an amount of tail gas being split into the tail gas stream directed to the tail gas expander inlet and the tail gas stream directed to means for pressurizing.

2. The system according to claim 1, wherein the system further comprises a tail gas heater, having an inlet in fluid communication with the absorption tail gas outlet and an outlet in fluid communication with the tail gas expander inlet, positioned upstream from the water cooler/condenser for heating the tail gas coming from the absorption tower to a temperature ranging between 200 to 650° C. with the heat from the NOₓ gas/steam mixture—coming from the ammonia converter, and wherein means for splitting the tail gas is positioned upstream from the tail gas heater.

3. The system according to claim 1, wherein the system further comprises a tail gas heater, having an inlet in fluid communication with the absorption tail gas outlet and an outlet in fluid communication with the tail gas expander inlet, positioned upstream from the water cooler/condenser for heating the tail gas coming from the absorption tower to a temperature ranging between 200 to 650° C. with the heat from the NOₓ gas/steam mixture coming from the ammonia converter, and wherein means for splitting the tail gas is positioned downstream from the tail gas heater.

4. The system according to claim 1, wherein the source of pressurized oxygen-rich gas is supplied by a high pressure water electrolyzer.

5. The system according to claim 1, further comprising a source of oxygen-rich gas having a pressure at least equal to atmospheric pressure, in fluid communication with the inlet of the air compressor.

6. The system according to claim 1, further comprising an additional source of pressurized oxygen-rich gas in fluid communication with an area downstream the absorption tower and upstream the means for pressurizing.

7. The system according to claim 1, further comprising a bleacher for bleaching raw nitric acid-containing residual NOₓ gas, comprising an inlet for an oxygen-rich bleaching gas, an inlet for the stream of raw nitric acid-containing residual NOₓ gas, an outlet for bleached nitric acid and an outlet for bleaching gases, wherein the outlet for the bleaching gases is in fluid communication with the gaseous NOₓ stream.

8. A method for producing nitric acid at reduced power consumption, comprising steps of:
a) compressing air in an air compressor, thereby producing a compressed air stream having a pressure P1;
b) mixing pressurized oxygen-rich gas having a pressure higher than P1 with the compressed air stream, thereby obtaining an oxygen-rich gas/compressed air stream mixture;
c) mixing the oxygen-rich gas/compressed air stream mixture with an ammonia gas stream in a mixing apparatus, thereby producing an ammonia/oxygen-enriched air mixture;
d) oxidising ammonia in the ammonia/oxygen-enriched air mixture in an ammonia converter at a temperature ranging from 800 to 950° C., thereby producing a gaseous NOₓ gas/steam mixture, comprising water and nitric oxide;
e) converting steam generated in the ammonia converter or from the gaseous NOₓ gas/steam mixture into power;
f) separating and condensing steam from NOₓ gas in the gaseous NOₓ gas/steam mixture, thereby generating an aqueous diluted nitric acid mixture and a gaseous NOₓ stream, in a water cooler/condenser;
g) absorbing the gaseous NOₓ stream in an absorption tower, thereby producing a stream of raw nitric acid-containing residual NOₓ gas and a tail gas comprising NOₓ gases; and
h) expanding the tail gas or heated tail gas in a tail gas expander; characterized in that the method further comprises the steps of:
i) pressurizing part of the tail gas obtained from step g) to a pressure about P1, thereby generating a pressurized tail gas;
j) mixing the pressurized tail gas with the compressed air stream;
k) measuring the temperature in the ammonia converter; and
I) adjusting a gas volume being pressurized in step i) if the temperature measured in step k) is outside a range of 800-950° C., such that the temperature in the ammonia converter is maintained in the range of 800 and 950° C.

9. The method according to claim 8, further comprising the step of:
m) heating the tail gas obtained in step g) to a temperature ranging from 200 to 650° C. in a tail gas heater positioned upstream from the water cooler/condenser with the heat from the NOₓ gas/steam mixture coming from the ammonia converter.

10. The method according to claim 8, further comprising the step of:
m′) heating the tail gas obtained in step g) to a temperature ranging from 200 to 650° C. in a tail gas heater positioned upstream from the water cooler/condenser with the heat from the NOₓ gas/steam mixture coming from the ammonia converter;
wherein, in step i), part of the tail gas obtained in step g) or in step m′) is pressurized.

11. The method according to a claim 8, further comprising the step of:
n) operating a high pressure water electrolyzer in order to produce the oxygen gas used in the mixing step b).

12. The method according to any claim 8, further comprising the step of:
o) sending an oxygen-rich gas having a pressure at least equal to atmospheric pressure to an inlet of the air compressor.

13. The method according to claim 8, further comprising the step of:
p) feeding an additional source of pressurized oxygen-rich gas downstream the absorption tower and upstream of means for pressurizing.

14. The method according to claim 8, further comprising the steps of:
q) feeding an oxygen-rich bleaching gas to a bleacher for bleaching raw nitric acid-containing residual NOₓ gas;
r) bleaching the stream of raw nitric acid-containing residual NOₓ gas in the bleacher, thereby generating bleached nitric acid and bleaching gases; and
s) mixing the bleaching gases with the gaseous NOₓ stream.

15. (canceled)

16. A method for revamping a existing system for producing nitric acid, wherein the existing system comprises:
an air compressor for compressing air to a pressure P1, comprising an inlet and an outlet, to provide in a compressed air stream;
a mixing apparatus for mixing the oxygen-rich gas/compressed air stream mixture with an ammonia gas stream, to provide in an ammonia/oxygen-enriched air mixture;
an ammonia converter for oxidising ammonia in the ammonia/oxygen-enriched air mixture, to provide in a NOₓ gas/steam mixture, comprising water and nitric oxide;
means for measuring the temperature in the ammonia converter;
means for regulating the concentration of ammonia and of oxygen in the ammonia converter;
a steam turbine or an electric motor and means for converting steam into electricity, for converting steam into power, in fluid communication with the ammonia converter or the NOₓ gas/steam mixture;
a water cooler/condenser separating and condensing steam from NOₓ gas in the gaseous NOₓ gas/steam mixture, to provide in an aqueous diluted nitric acid mixture and a gaseous NOₓ stream;
an absorption tower downstream the water cooler/condenser for absorbing NOₓ gases in water, to provide in a stream of raw nitric acid-containing residual NOₓ gas and a tail gas comprising NOₓ gases, comprising an absorption tower tail gas outlet for evacuating the tail gas; and
a tail gas expander for expanding the tail gas downstream of the absorption tower comprising a tail gas expander inlet in fluid communication with the absorption tower tail gas outlet, and a tail gas expander outlet;
into the system according to claim 1, comprising steps of:
introducing means for splitting the tail gas into a first tail gas stream directed to the tail gas expander inlet and a second tail gas stream directed to means for pressurizing for pressurizing the tail gas stream to a pressure of about P1 in fluid communication with the compressed air stream, to provide in a pressurized tail gas stream joining the compressed air stream; and introducing means for adjusting the amount of tail gas being splitted split into the first tail gas stream directed to the tail gas expander inlet and a second tail gas stream directed to means for pressurizing, and
introducing a source of pressurized oxygen-rich gas said pressurized oxygen-rich gas having a pressure higher than the pressure of the compressed air stream, and fluidly connecting the source of pressurized oxygen-rich gas with the compressed air stream, to provide in an oxygen-rich gas/compressed air stream mixture.

17. The method according to claim 16, where the source of the pressurized oxygen-rich gas is a high pressure electrolyzer.

18. The method according to claim 8, wherein the ammonia/oxygen-enriched air mixture has an oxygen to ammonia molar ratio ranging from 1.3 to 9.
